(19) United States
(12) Patent Application Publication
(10) Pub. No.: US 2018/0110095 A1
(43) Pub. Date: Apr. 19, 2018

(54) HEAT COMPRESS DEVICE WITH WIRELESS CHARGING FUNCTION AND HEAT COMPRESS SYSTEM WITH WIRELESS CHARGING FUNCTION

(71) Applicant: PO-CHIH LAI, TAICHUNG CITY (TW)

(72) Inventor: PO-CHIH LAI, TAICHUNG CITY (TW)

(21) Appl. No.: 15/492,648

(22) Filed: Apr. 20, 2017

(30) Foreign Application Priority Data
Oct. 19, 2016 (TW) 105133695

(51) Int. Cl. H05B 1/02; H02J 50/12; H02J 7/02

(52) U.S. Cl. CPC H05B 1/025; H02J 7/025; H02J 50/12

(57) ABSTRACT

A heat compress system with a wireless charging function includes a heat compress device with a wireless charging function and a wireless charging station. The heat compress device with a wireless charging function includes a first processing module, a receiving resonator electrically connected to the first processing module through adjustable matching circuit, rectifying module, power managing module, and heating module, and at least one heating module electrically connected to the first processing module and the receiving resonator through power managing module, rectifying module, and adjustable matching circuit. The wireless charging station includes a transmitting resonator for providing a wireless power to the heat compress device with a wireless charging function. The receiving resonator receives the wireless power transmitted by the transmitting resonator, and transfers the wireless power to the heating module for heat generation. The first processing module adjusts a temperature of the heating module.

### BACKGROUND

### 1. Technical Field

The present disclosure relates to a heat compress device, and in particular, to a heat compress device with a wireless charging function.

### 2. Description of Related Art

Heat or cold compressions are common methods in non-invasive treatment. The heat compress can not only improve the blood circulation of a body, but also contribute to overall health improvement.

According to traditional Chinese medicine theories, the best heat compress treatment should last 3-6 hours to achieve better therapeutic effect. However, today's heat compress devices are equipped with a power cord. If a user uses a heat compress device with the power cord and stays in the same position for 3-6 hours, he or she cannot enjoy a convenient treatment process due to space and wire restrictions.

Therefore, providing a heat device without the wire restriction has become an important issue in the art.

### SUMMARY

In order to achieve the above purposes, a heat compress system with a wireless charging function is provided in the present disclosure. The heat compress system with a wireless charging function includes a heat compress device with a wireless charging function and a wireless charging station. The heat compress device with a wireless charging function includes a first processing module, a receiving resonator, electrically connected to the first processing module through adjustable matching circuit, rectifying module, power managing module, and heating module, and at least one heating module, electrically connected to the first processing module and the receiving resonator through power managing module, rectifying module, and adjustable matching circuit. The wireless charging station includes a transmitting resonator for providing a wireless power to the heat compress device with a wireless charging function. The receiving resonator receives the wireless power transmitted by the transmitting resonator of the wireless charging station, and transfers the wireless power to the at least one heating module for heat generation. The first processing module adjusts a temperature of the heating module.

In order to achieve the above purposes, a heat compress device with a wireless charging function is further provided in the present disclosure. The wireless charging function includes a first processing module, a receiving resonator receiving a wireless power from a wireless charging station and being electrically connected to the first processing module through adjustable matching circuit, rectifying module, power managing module, and heating module, and at least one heating module electrically connected to the first processing module and power managing module. The first processing module adjusts a temperature of the at least one heating module.

According to the above, the heat compress system with a wireless charging function of the present disclosure provides the wireless power without the need for power cords. The heat compress system of the present disclosure further stores and records the programmable temperature-timing setting data for different users. When a user re-uses the heat compress system, the heat compress system immediately recalls all of the temperature-timing setting data for the user, so that they need not be set again. The heat compress system can also adjust the temperature and the timing of the heat compress device based on the user's stored records. Therefore, the heat compress system of the present disclosure provides a convenient experience for a user without being restricted by a wire (power cord).

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the present disclosure.

FIG. 1 is a schematic diagram of a heat compress system with a wireless charging function according to an embodiment of the present disclosure.

FIG. 2 is another schematic diagram of a heat compress system with a wireless charging function according to an embodiment of the present disclosure.

FIG. 3 is a schematic diagram of a heating module according to an embodiment of the present disclosure.

FIG. 4A is a temperature chart of the heat compress system with a wireless charging function according to an embodiment of the present disclosure.

FIG. 4B is another temperature chart of the heat compress system with a wireless charging function according to an embodiment of the present disclosure.

FIG. 4C is another temperature chart of the heat compress system with a wireless charging function according to an embodiment of the present disclosure.

FIG. 5 is another schematic diagram of a heat compress system with a wireless charging function according to an embodiment of the present disclosure.

FIG. 6 is another schematic diagram of a heat compress system with a wireless charging function according to an embodiment of the present disclosure.

FIG. 7 is a schematic diagram of the heat compress system with a wireless charging function cooperating with a mobile device.

FIG. 8 is another schematic diagram of a heat compress system with a wireless charging function according to an embodiment of the present disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

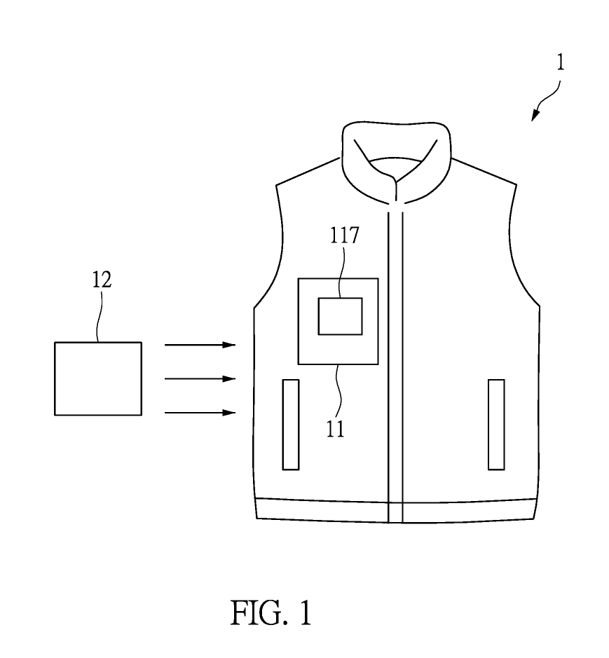

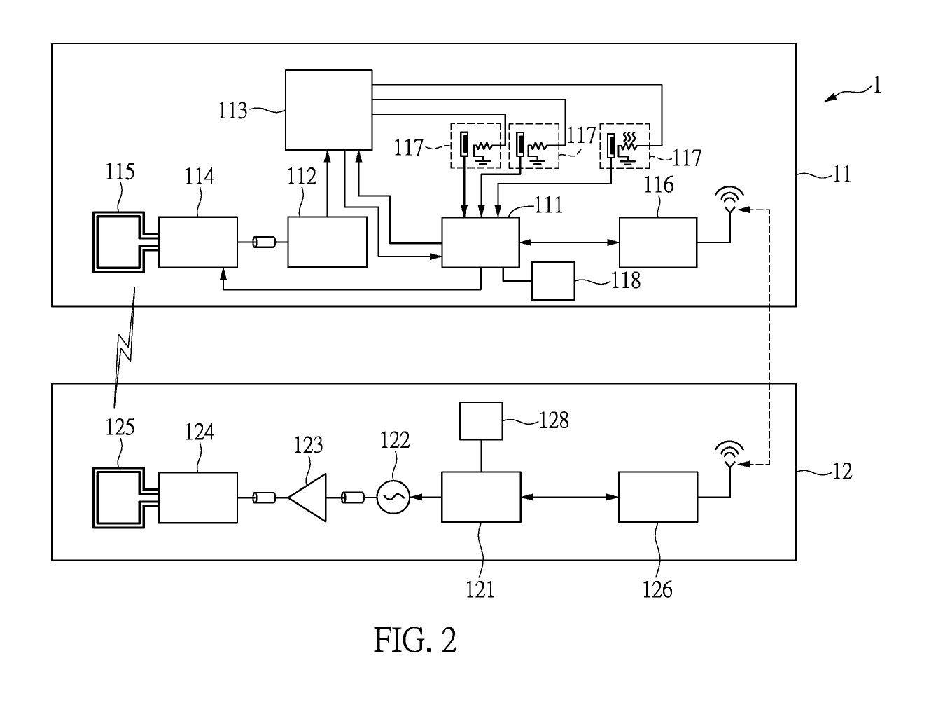

Referring to FIGS. 1-3, a heat compress system with a wireless charging function 1 includes a heat compress device with a wireless charging function 11 and a wireless charging station 12. The wireless charging station 12 provides a wireless power to the heat compress device with a wireless charging function 11.

The heat compress device with a wireless charging function 11 includes a first processing module 111, a rectifying module 112, a power managing module 113, an adjustable matching circuit 114, a receiving resonator 115, a first wireless communication module 116 and a plurality of heating modules 117.

In the embodiment, the processing module 111 is electrically connected to the power managing module 113, the wireless communication module 116, the adjustable matching circuit 114, and the heating modules 117. The receiving resonator 115 is electrically connected to the adjustable matching circuit 114. The adjustable matching circuit 114 is electrically connected to the rectifying module 112. The rectifying module 112 is electrically connected to the power managing module 113. The power managing module 113 is electrically connected to the heating modules 117.

The wireless charging station 12 includes a second processing module 121, a frequency synthesizer 122, a power amplifying module 123, a matching circuit 124, a transmitting resonator 125 and a second wireless communication module 126.

In the embodiment, the wireless charging station 12 provides the wireless power to the heating module 117 of the heat compress device with a wireless charging function 11 by the transmitting resonator 125.

The wireless charging station 12 transfers the electric energy of AC mains or a power source (not shown) through the transmitting resonator 125, and the receiving resonator 115 of the heat compress device with a wireless charging function 11 receives the wireless power from the transmitting resonator 125.

A magnetic resonant coupling technology is used in the embodiment of the present disclosure, which is a non-radiated magnetic coupling technology. A strong coupling effect only occurs on objects that have the same resonant frequency. If two objects have different resonant frequencies, the coupling between them is very weak.

In the embodiment, the wireless charging station 12 and the heat compress device with a wireless charging function respectively includes the matching circuit 124 and the adjustable matching circuit 114 such that the wireless power transferred between the transmitting resonator 125 and the receiving resonator is optimized. The wireless charging station 12 transfers the electric power into an electrical signal with a specific frequency by the synthesizer 122 and the power amplifying module 123. Then the electric power is transmitted through the matching circuit 124 and the transmitting resonator 125. Since the receiving resonator 115 of the heat compress device with a charging function 11 operates with a frequency similar to that of the transmitting resonator 125, the wireless power is transmitted between the transmitting resonator 125 and the receiving resonator 115.

When the receiving resonator 115 receives the wireless power from the transmitting resonator 125, the electric power is transmitted to the rectifying module 112 for rectifying, filtering and generating a direct current voltage (DC voltage). The DC voltage is then processed by the power managing module 113 and transmitted to the heating module 117.

In the embodiment, the power managing module 113 includes a buck/boost converter (not shown). Even if the electric power received by the receiving resonator 115 is filtered and outputted at a stable voltage, the received power is insufficient to provide for the heating device 117 due to variable distance between the receiving resonator 115 and the transmitting resonator 125. Therefore, buck/boost converter (not shown) of the power managing module 113 adjusts the voltage of the received power. In the embodiment, the buck/boost converter (not shown) serves as a buck converter to provide a voltage for the heating module 117 when the voltage of the received power is higher than a threshold value. In other words, the buck/boost converter (not shown) is considered as a boost converter to provide a stable voltage for the heating module 117 when the voltage of the received power is less than another threshold value.

In the embodiment, the first wireless communication module 116 and the first wireless communication module 126 are wireless communication modules that are out-of-band wireless communication modules and that have low power consumption. The first wireless communication module 116 and the first wireless communication module 126 are used for adjusting the communication of the wireless power transferred between the heat compress device and the wireless charging station. In other embodiments of the present disclosure, the first communication module 116 and the second communication module 126 include a low energy communication module, but are not limited thereto. The temperature-timing setting data or other data is transmitted by the first communication module 116 to the second communication module 126 and stored in a storage module (not shown) of the wireless charging station 12. In addition, an identification data and the temperature-timing setting data can be transmitted to the wireless charging station 12. When a user next uses the heat compress device with a wireless charging function 11, the temperature-timing setting data can be recalled by the user interface to execute the heat compress process. In other embodiments of the present disclosure, the identification data of the user and the temperature-timing setting data can also be stored in the heat compress device with a wireless charging function 11 for easy use.

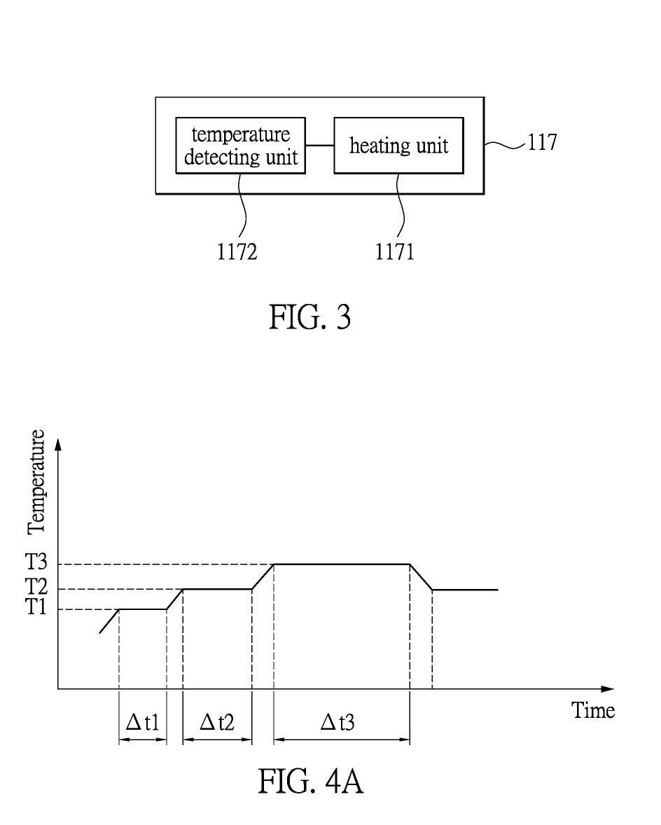

Referring to FIG. 3, the heating module 117 includes a heating unit 1171 and a temperature detecting unit 1172. In the embodiment, the heating unit 1171 is a heating component that is electrically connected to the power managing module 113. The temperature detecting unit 1172 is located at one side of the heating unit 1171 for detecting a temperature of the heating unit 1171. In practice, the heating unit 1171 is often covered by a heat-conductive material for heat conduction. The temperature detecting unit 1172 is located at one side of the heat-conductive material for detecting the temperature at the one side of the heat-conductive material, but not limited thereto. In the embodiment, the heating unit 1171 is an adjustable heating component. The temperature detecting unit 1172 is an electric thermometer and electrically connected to the first processing module 111 through adjustable matching circuit 114, rectifying module 112, power managing module 113, and heating module 117. The temperature detecting unit 1172 transmits at least one temperature detecting signal to the first processing module 111. The first processing module 111 controls the power managing module 113 to provide the electric power to the heating unit 1172 for adjusting the temperature of the heating unit 1172 according to the temperature detecting signals from the temperature detecting unit 1172.

In the embodiment, the heat compress device with a wireless charging function 11 further includes a timing module 118 that is used for counting and recording the temperature-timing setting data of the heating module 117. The wireless charging station 12 further includes a timing module 128, which is the same as the timing module 118 of the heat compress device with a wireless charging function 11.

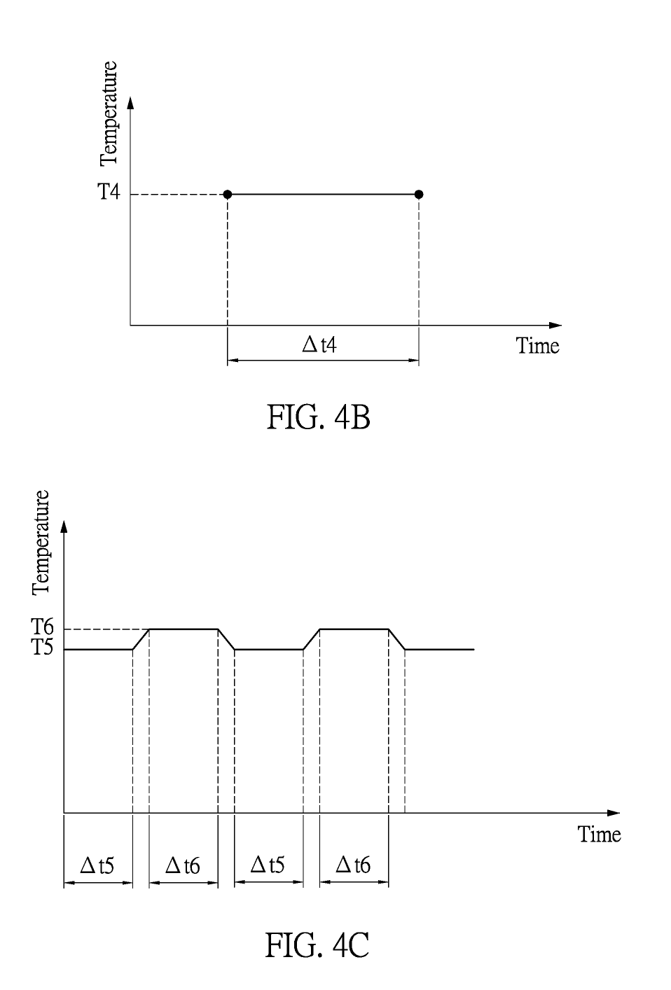

In the embodiment, the temperature-timing setting data is programmed by the user. The user can set the temperature-timing setting data through a user interface (not shown) of the heat compress device with a wireless charging function 11. The user can set the temperature of the heat compress device with a wireless charging function 11 to be maintained at 40° C. for 10 minutes, then be maintained at 42° C. for 15 minutes, then be maintained at 45° C. for 25 minutes, and finally be maintained at 42° C. for 15 minutes. After setting the temperature-timing setting data, the temperature-timing setting data of the heating module 117 is recorded by the timing module 118 and transmitted to the power managing module 113 and the first processing module 111, and the first processing module 111 and the power managing module 113 adjust the temperatures in different time periods of the heating module 117 according to the temperature-timing setting data. As shown in FIG. 4A, temperatures in different time periods of the heating module are programmable. In the embodiment, the power managing module 113 provides the electric power to each of the heating modules 117 according to the control signals of the first processing module 111, i.e., the power managing module 113 can selectively provide the electric power to one or more of the heating modules 117. In the embodiment, the first processing module 111 further includes a storage unit (not shown). The temperature-timing setting data can be pre-stored in the storage unit (not shown) such that the first processing module 111 rapidly adjusts the heating modules 117 according to the temperature-timing setting data.

Reference is next made to FIG. 4A, FIG. 4B and FIG. 4C. As shown in FIG. 4A, three temperatures are respectively set for three time periods. A first temperature T1 is set in the first time period Δt1, a second temperature T2 is set in the second time period Δt2, and a third temperature T3 is set in the third time period Δt3. Since the first processing module 111 is electrically connected to each heating module 117. the first processing module 111 adjusts the temperatures of the heating module 117 according to the temperature detecting signals from the temperature detecting unit 1172 of each heating module 117 and the temperature of each heating module 117 is maintained at a constant value or within a predetermined temperature range. As shown in FIG. 3, the temperature of the heating module 117 is maintained in a temperature range. The temperature range in the embodiment is between the third temperature T3 and the first temperature T1. The first temperature T1 is 35° C., the second temperature T2 is 40° C., and the third temperature T3 is 45° C. The temperature of the heating module 117 is between 35° C. and 45° C., i.e., the heat dissipated by the heating module 117 causes a larger fluctuation in temperature. In practice, due to the large fluctuation in temperature, the rate of change of the temperature should be taken into consideration. In the embodiment, the first processing module 111 can further adjust the rate of change of the temperature of the heating module, such as at 2° C./minute or 0.5° C./minute.

As shown in FIG. 4B, a fourth temperature T4 is set in a fourth time period Δt4. As shown in FIG. 4C, the a fifth temperature T5 and a sixth temperature T6 are respectively set in a fifth time period Δt5 and a sixth time period. In the embodiment, the above cycle is conducted two times, but the number of conducted cycles can be varied in other embodiments of the present disclosure.

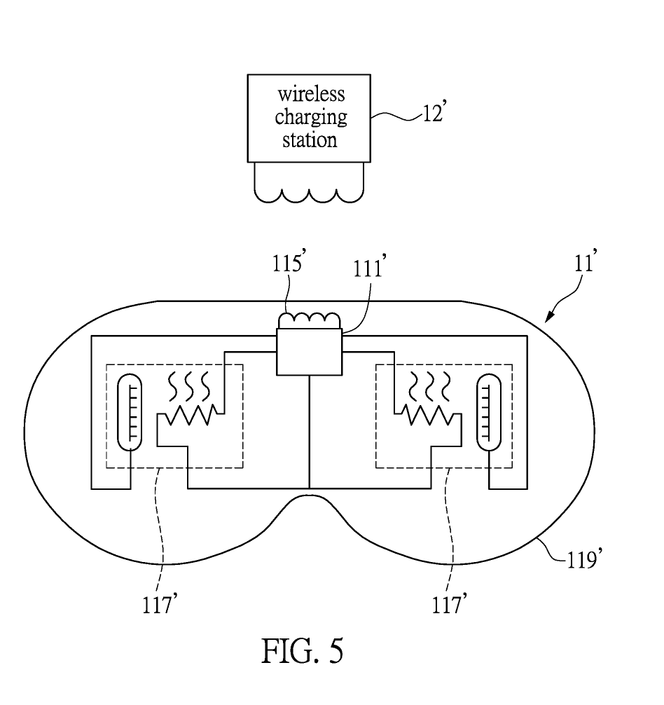

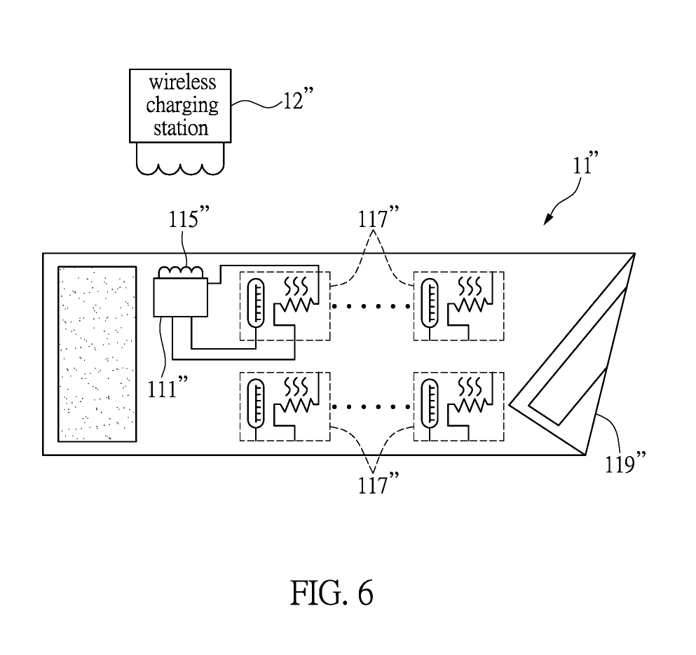

In the embodiment, the heat compress device with a wireless charging function 11 is disposed in an inner surface of a vest 13 as a thermal pack when the user wears the vest 13. In other embodiments of the present disclosure, the heat compress device with a wireless charging function 11 can be disposed in an eyeshade (as shown in FIG. 5), a kneepad, a wrist or a belt (as shown in FIG. 6).

Referring to FIG. 5 and FIG. 6, the heat compress device with a wireless charging function 11′ includes an eyeshade-like carrier 119′. The material of the eyeshade-like carrier 119′ is cotton. Two heating units 117′ are adjacently disposed on the eyeshade-like carrier 119′. The wireless heat compress device with a wireless charging function 11′ can be applied to an upper eyelid of the user and to an area near the eye of the user.

The wireless charging station 12′ transmits the wireless power to the receiving resonator 115′. The first processing module 111′ controls and coordinates the receiving power to the heating unit 117′ for heat generation.

The heat compress device 11″ in FIG. 6 includes a belt-shaped carrier 119″. A plurality of heating units 117″ is detachably disposed on the belt-shaped carrier 119″. The locations of the heating units 117″ can be arranged according to practical requirements. Furthermore, the belt-shaped carrier 119″ is replaceable. The size and the material of the belt-shaped carrier 119″ can be variable according to practical requirements. In the embodiment, the heat compress device with a wireless charging function 11″ is mounted on the belt-shaped carrier 119″ by a fixing module (not shown). The fixing module (not shown) includes a devil felt, a button, a zipper, but is not limited thereto.

In another embodiment, the heat compress device with a wireless charging function 11 can be mounted on an adhesive patch, so that the heat compress device with a wireless charging function 11 can be applied adhesively to the location where treatment is required.

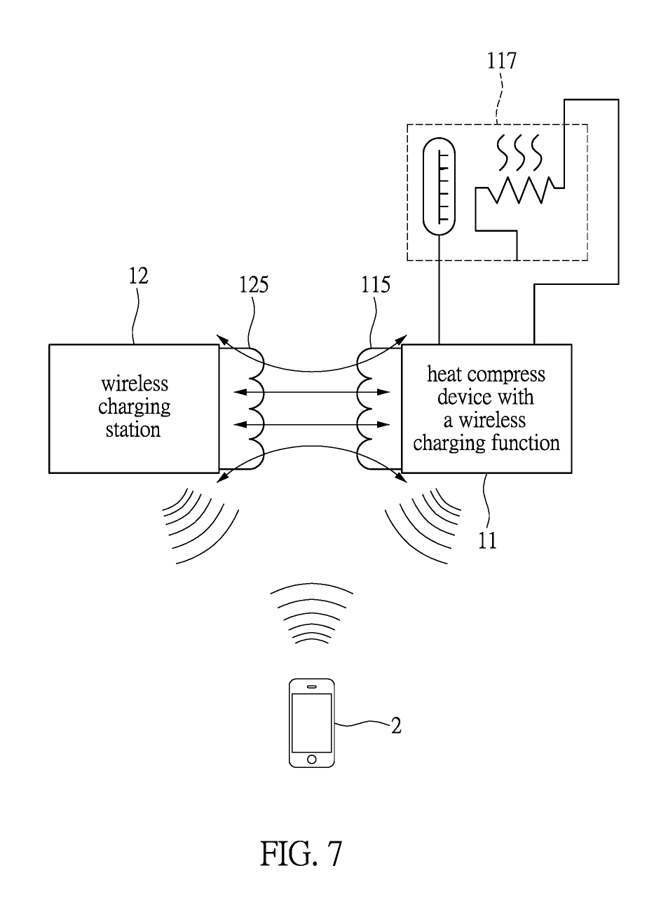

Referring to FIG. 7, in the embodiment, the user can use a mobile device 2 to adjust the setting data of the heat compress system with a wireless charging function 1.

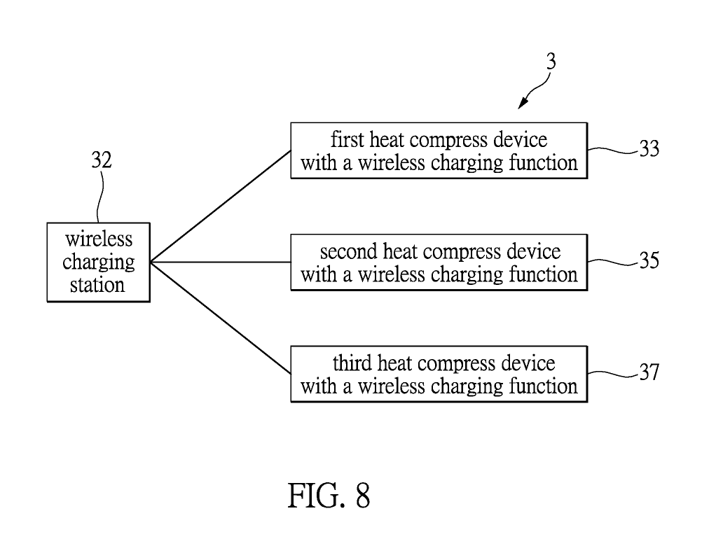

Referring to FIG. 8, the heat compress system with a wireless charging function 3 includes a wireless charging station 32, a first heat compress device with a wireless charging function 33, a second heat compress device with a wireless charging function 35 and a third heat compress device with a wireless charging function 37. In this embodiment, the structure and the function of the wireless charging station 32 is the same as the wireless charging station 12 of the above embodiment. The structure and the function of the first heat compress device with a wireless charging function 33, the second heat compress device with a wireless charging function 35, and the third heat compress device with a wireless charging function 37 are the same as that of the heat compress device with a wireless charging function 11 of the above embodiment, which is omitted in this embodiment. In other embodiments of the present disclosure, the wireless charging station 32 further includes a plurality of transmitting resonator (not shown) for transmitting wireless power to the first heat compress with a wireless charging function 33, the second heat compress with a wireless charging function 35, and the third heat compress with a wireless charging function 37, respectively.

In other embodiments of the present disclosure, the first heat compress device with a wireless charging function 33, the second heat compress device with a wireless charging function 35, and the third heat compress device with a wireless charging function 37 are different types of heat compress devices. For example, the first heat compress device with a wireless charging function 33 is a vest, the second heat compress device with a wireless charging function 35 is an adhesive patch, and the third heat compress device with a wireless charging function 37 is a belt-shaped heat compress device.

In the embodiment, the wireless charging station 32 simultaneously provides the wireless power to the first heat compress device with a wireless charging function 33, the second heat compress device with a wireless charging function 35, and the third heat compress device with a wireless charging function 37, and stores the temperature-timing setting data of the first heat compress device with a wireless charging function 33, the second heat compress device with a wireless charging function 35, and the third heat compress device with a wireless charging function 37.

According to the above, the heat compress system with a wireless charging function of the present disclosure provides the wireless power without the need for power cords. The heat compress system of the present disclosure further stores and records programmable temperature-timing setting data for different users. When the user re-uses the heat compress system, the heat compress system immediately recalls all of the temperature-timing setting data for the user so that they need not be set again. The heat compress system with a charging function also can adjust the temperature and the timing of the heat compress device based on the user's stored records. Therefore, the heat compress system of the present disclosure provides a convenient experience for the user without being restricted by a wire (power cord).

The above-mentioned descriptions represent merely the exemplary embodiments of the instant disclosure, without any intention to limit the scope of the instant disclosure thereto. Various equivalent changes, alterations or modifications based on the claims of present disclosure are all consequently viewed as being embraced by the scope of the instant disclosure.

What is claimed is:

1. A heat compress system with a wireless charging function comprising:
a heat compress device with a wireless charging function including:
a first processing module;
a receiving resonator, electrically connected to the first processing module through adjustable matching circuit, rectifying module, power managing module, and heating module; and at least one heating module, electrically connected to the first processing module and the receiving resonator through power managing module, rectifying module, and adjustable matching circuit; and
a wireless charging station, including:
a transmitting resonator, providing a wireless power to the heat compress device with a wireless charging function.;
wherein the receiving resonator receives the wireless power transmitted by the transmitting resonator of the wireless charging station, and transfers the wireless power to the at least one heating module for heat generation;
wherein the first processing module adjusts a temperature of the heating module.

2. The heat compress system with a wireless charging function of claim 1, wherein the temperature of the at least one heating module is maintained at a constant temperature by the processing module.

3. The heat compress system with a wireless charging function of claim 1, wherein temperature of the at least one heating module is maintained in a temperature range.

4. The heat compress system with a wireless charging function of claim 1, wherein the temperature of the at least one heating module is maintained at a constant temperature for a predetermined time period.

5. The heat compress system with a wireless charging function of claim 1, wherein the heating module includes:
a heating unit; and
a temperature detecting unit electrically connected to the first processing module and used for detecting the temperature of the heating module, the temperature detecting unit transmitting a temperature detecting signal to the first processing module;
wherein the first processing module adjusts the temperature of the heating module according to the temperature detecting signal.

6. The heat compress system with a wireless charging function of claim 1, wherein the heat compress device with a wireless charging function further includes:
a timing module, electrically connected to the first processing module;
wherein the first processing module adjusts the temperature of the heating module according to a temperature-timing setting data through the timing module.

7. A heat compress device with a wireless charging function comprising:
a first processing module;
a receiving resonator, receiving a wireless power from a wireless charging station, the receiving resonator being electrically connected to the first processing module through adjustable matching circuit, rectifying module, power managing module, and heating module; and
at least one heating module, electrically connected to the first processing module and the receiving resonator through power managing module, rectifying module, and adjustable matching circuit;
wherein the first processing module adjusts a temperature of the at least one heating module.

8. The heat compress device with a wireless charging function of claim 7, wherein the temperature of the at least one heating module is maintained at a constant temperature or in a temperature range by the processing module.

9. The heat compress device with a wireless charging function of claim 7, wherein the temperature of the at least one heating module is maintained at a constant temperature for a predetermined time period.

10. The heat compress device with a wireless charging function of claim 7, wherein the heating module includes:
a heating unit; and
a temperature detecting unit electrically connected to the first processing module and used for detecting the temperature of the heating module, the temperature detecting unit transmitting a temperature detecting signal to the first processing module;
wherein the first processing module adjusts the temperature of the heating module based on the temperature detecting signal.

11. The heat compress device with a wireless charging function of claim 7 further comprising:
a timing module, electrically connected to the first processing module;
wherein the first processing module adjusts the temperature of the heating module according to a temperature-timing setting data through the timing module.
